(19) United States
(12) Patent Application Publication
(10) Pub. No.: US 2025/0377503 A1
(43) Pub. Date: Dec. 11, 2025

(54) OPTICAL COMPONENT, OPTICAL MODULE AND MANUFACTURING METHOD FOR OPTICAL MODULE

(71) Applicant: Nippon Telegraph and Telephone Corporation, Tokyo (JP)

(72) Inventor: Takuya Tanaka, Tokyo (JP)

(21) Appl. No.: 18/877,525

(22) PCT Filed: Aug. 30, 2022
(86) PCT No.: PCT/JP2022/032512

§ 371 Date: Dec. 20, 2024

(51) Int. Cl. G02B 6/36; G02B 6/42

(52) U.S. Cl. CPC G02B 6/3636; G02B 6/3684; G02B 6/423; G02B 6/4239; G02B 6/4243

(57) ABSTRACT

An optical component includes an optical waveguide, a separation groove disposed on both sides of the optical waveguide in an end face of the optical component connected to face an end face of another optical component, wherein the end face inside the separation groove is in a mirror surface state, and at least a part of the end face outside the separation groove has unevenness.

### CROSS-REFERENCE TO RELATED APPLICATIONS

This application is a national phase entry of PCT Application No. PCT/JP2022/032512, filed on Aug. 30, 2022, which application is hereby incorporated herein by reference.

### TECHNICAL FIELD

The present invention relates to an optical component such as an optical fiber or an optical waveguide element, an optical module to which the optical component is connected, and a method for manufacturing the optical module.

### BACKGROUND

In the fields of optical communication and sensing, optical modules to which optical components are connected are used. For example, an optical module in which an optical fiber and an optical waveguide element chip are connected via a fiber block has been disclosed (for example, Patent Literature 1).

As an example, as illustrated in FIG. 7, an optical module 20 has a configuration in which an optical fiber 211 and a quartz-based planar lightwave circuit (PLC) chip 22 are connected via a fiber block 21.

In the optical module 20, an optical signal is input from one optical fiber 211 to an optical circuit 222 on a substrate 221 in the PLC chip 22, and an optical signal subjected to signal processing in the optical circuit 222 is output from the other optical fiber 211.

In the fiber block 21, the optical fiber 211 is sandwiched and fixed between a pressing lid 213 and a V-groove substrate 212. A glass plate 223 is disposed at an end of the PLC chip 22. As a result, in fixing (bonding) of the fiber block 21 and the end face of the PLC chip 22, the bonding area is enlarged and the bonding strength is increased.

In an optical module used for optical communication, an adhesive having a refractive index equivalent to that of glass with respect to light in a communication region (near-infrared light from a wavelength of 1.3 μm to a wavelength of 1.6 μm) and having adhesive strength is used for fixing (bonding) an optical waveguide chip and a fiber block.

Further, as illustrated in FIG. 8, a configuration in which two separation grooves 314 are disposed in the fiber block 31 of the optical module is disclosed (Patent Literatures 2 and 3). By the separation groove 314, the end face of the fiber block 31 is horizontally (in an x direction in the drawing) separated into a portion (hereinafter, referred to as an “inner portion”) 316 including a region where a waveguide is formed inside the separation groove 314 and light propagates and a portion (hereinafter, referred to as an “outer portion”) 317 where light does not propagate outside the separation groove 314.

In the optical module to which the fiber block 31 and the PLC chip (not illustrated) are connected, assuming high-output light of about 1 W, the inner portion 316 between the fiber block 31 and the PLC chip can be filled with a resin having light resistance, and the outer portion 317 can be filled with an adhesive having adhesive strength. In the inner portion 316, the gap may be configured as air, or the fiber block 31 and the PLC chip may be in physical contact with each other.

In the fiber block 31, as illustrated in FIG. 8, the optical fiber 311 is disposed in the V-groove 315 of the V-groove substrate 312, and is sandwiched and fixed by the pressing lid 313. In addition, a separation groove 314 is provided on the end face of the fiber block 31, and the inner portion 316 and the outer portion 317 are separated. In the fixing (bonding) of the fiber block 31 and the PLC chip (not illustrated), when an ultraviolet-curable adhesive is filled between the outer portion 317 of the fiber block 31 and the end face portion of the PLC chip facing the outer portion 317, the adhesive can be prevented from flowing into the inner portion 316 of the fiber block 31 and blocked by the separation groove 314.

Here, the entire end face of the fiber block 31 is mirror-polished. That is, the inner portion 316 and the outer portion 317 are mirror-polished.

When the fiber block 31 is connected to the PLC chip, the fiber block 31 and the PLC chip are separated by several micrometers, and the optical axes of the optical fibers 311 fixed to the fiber block 31 and the waveguides of the PLC chip are aligned. Thereafter, an ultraviolet-curable adhesive is injected between the end faces of the fiber block 31 and the PLC chip in the outer portion 317, and the adhesive is irradiated with ultraviolet light to be cured. Here, the adhesive can be prevented from flowing into the inner portion 316 and blocked by the separation groove 314. Subsequently, a light-resistant resin is injected between the end faces of the fiber block 31 and the PLC chip in the inner portion 316.

In this way, the fiber block 31 is connected to the PLC chip, and the optical module is manufactured.

### CITATION LIST

### Patent Literature

Patent Literature 1: JP H8-313744 A
Patent Literature 2: JP 2017-54110 A
Patent Literature 3: JP 2019-95485 A

### SUMMARY

### Technical Problem

However, in the optical module, the fiber block 31 and the PLC chip are bonded only at the outer portion 317 in the end face, and are not bonded over the entire end face.

As a result, when the optical module is downsized, the bonding area decreases as the areas of the end faces of the fiber block and the PLC chip decrease, so that the fixing strength (bonding strength) between the fiber block and the PLC chip decreases.

In addition, when a fiber block having a plurality of optical fibers and a PLC chip having a multi-core waveguide are connected, the area of the outer portion (portion to be bonded) relative to the area of the inner portion is relatively reduced, so that the fixing strength (bonding strength) between the fiber block and the PLC chip is reduced.

### Solution to Problem

In order to solve the above-described problem, an optical component according to embodiments of the present invention includes: an optical waveguide and a separation groove disposed on both sides of the optical waveguide in the horizontal direction in an end face of the optical component connected to face an end face of another optical component, in which the end face inside the separation groove in the horizontal direction is in a mirror surface state, and at least a part of the end face outside the separation groove in the horizontal direction has unevenness.

Further, a method for manufacturing an optical module according to embodiments of the present invention is a method for manufacturing an optical module in which each of two optical components includes an optical waveguide and the optical components are connected at respective end faces, and at least one of the optical components includes separation grooves on both sides of the optical waveguide at the end face, the method including: a step of mirror-polishing an entire surface of an end face of the one optical component; a step of forming a masking inside the separation groove in the horizontal direction on an end face of the one optical component, and forming unevenness outside the separation groove in the horizontal direction; a step of removing the masking; and a step of aligning the optical waveguides of the one optical component and the other optical component, and bonding the outer side of the end face of the one optical component to the end face of the other optical component.

Further, a method for manufacturing an optical module according to embodiments of the present invention is a method for manufacturing an optical module in which each of two optical components includes an optical waveguide and the optical components are connected at respective end faces, and at least one of the optical components includes separation grooves on both sides of the optical waveguide at the end face, the method including: a step of polishing the entire end face of the one optical component; a step of forming a masking inside the separation groove in the horizontal direction on an end face of the one optical component, and forming unevenness outside the separation groove in the horizontal direction; a step of removing the masking; a step of mirror-polishing the inner side of the end face of the one optical component; and a step of aligning the optical waveguides of the one optical component and the other optical component, and bonding the outer side of the end face of the one optical component to the end face of the other optical component.

### Advantageous Effects

According to embodiments of the present invention, it is possible to provide an optical component and an optical module that are firmly connected and a method for manufacturing the optical module.

### BRIEF DESCRIPTION OF THE DRAWINGS

FIG. 1 is a bird's-eye view schematically illustrating a configuration of an optical module according to a first embodiment of the present invention.

FIG. 2 is a bird's-eye view schematically illustrating a configuration of a fiber block in the optical module according to the first embodiment of the present invention.

FIG. 3A is a view for describing an effect of the optical module according to the first exemplary embodiment of the present invention.

FIG. 3B is a view for describing an effect of the optical module according to the first exemplary embodiment of the present invention.

FIG. 4 is a flowchart for describing an example of a method of manufacturing the optical module according to the first embodiment of the present invention.

FIG. 5 is a side cross-sectional view illustrating a configuration of the optical module according to the first embodiment of the present invention.

FIG. 6 is a flowchart for describing an example of a method for manufacturing an optical module according to a second embodiment of the present invention.

FIG. 7 is a bird's-eye view schematically illustrating a configuration of an optical module in the related art.

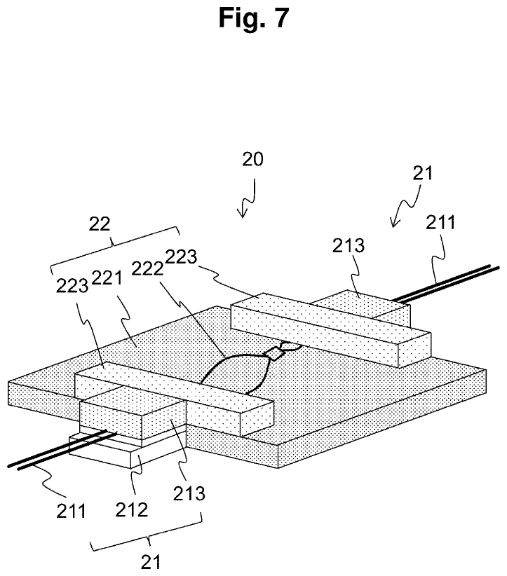

FIG. 8 is a bird's-eye view schematically illustrating a configuration of a fiber block in an optical module in the related art.

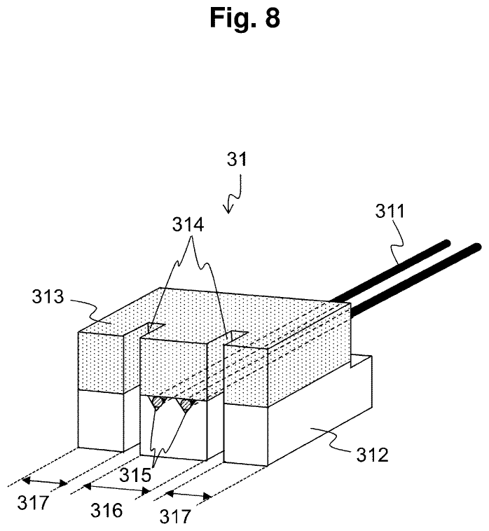

### DETAILED DESCRIPTION OF ILLUSTRATIVE EMBODIMENTS

### First Embodiment

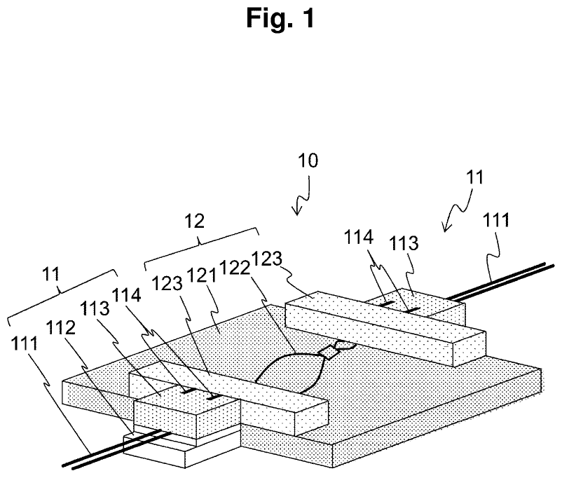

An optical component and an optical module according to a first embodiment of the present invention will be described with reference to FIGS. 1 to 5.

### Configuration of Optical Component and Optical Module

In the optical module 10 according to the present embodiment, as illustrated in FIG. 1, as an optical component, a fiber block 11 and an optical waveguide element chip 12 are connected in a light guiding direction (a y direction in the drawing).

The fiber block 11 includes an optical fiber 111, a V-groove substrate 112, and a pressing lid 113, and the optical fiber 111 is sandwiched and fixed between the V-groove substrate 112 and the pressing lid 113. The fiber block 11 has a separation groove 114 (described below).

As an example, a PLC chip in which the optical circuit 122 is formed on the substrate 121 is used as the optical waveguide element chip 12. In addition, in order to increase the bonding (fixing) strength between the fiber block 11 and the end face of the PLC chip 12, a glass plate 123 is disposed at the end of the surface of the optical waveguide element chip 12.

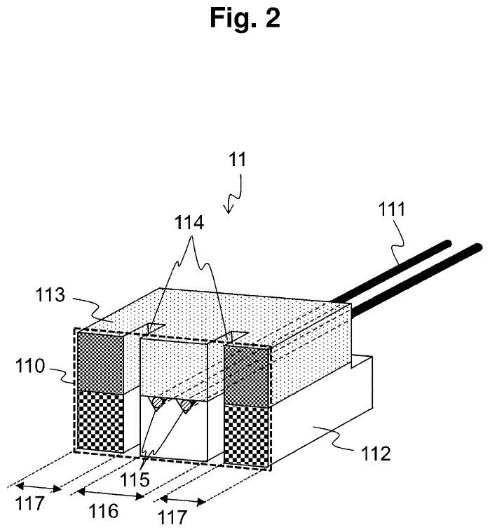

FIG. 2 illustrates a detailed configuration of the fiber block 11. The optical fiber 111 is disposed in a V-shaped groove 115 formed on the surface of the V-groove substrate 112. The pressing lid 113 is disposed on the surface of the V-groove substrate 112 on which the optical fiber 111 is disposed. Here, as a material of the V-groove substrate 112 and the pressing lid 113, for example, glass such as TEMPAX Float (registered trademark) is used. The fiber block 11 has a width (an x direction) of about 5 mm, a length (a y direction) of about 6 mm, and a height (a z direction) of about 2 mm.

In addition, the fiber block 11 has separation grooves 114 on both sides in the horizontal direction (the x direction in the drawing) with respect to the region where the optical fiber 111 is disposed. By the separation groove 114, the end face 110 of the fiber block 11 is horizontally separated into a portion (hereinafter, referred to as an “inner portion”) 116 including a region (a region where the optical fiber is disposed) where the waveguide is formed inside the separation groove 114 and light propagates and a portion (hereinafter, referred to as an “outer portion”) 117 where light does not propagate outside the separation groove 114.

In the fixing (bonding) of the fiber block 11 and the optical waveguide element chip 12, when an adhesive is filled between the outer portion 117 of the end face of the fiber block 11 and the end face of the optical waveguide element chip 12 facing the outer portion 117, the adhesive can be prevented from flowing into the inner portion 116 and blocked by the separation groove 114.

Here, in the end face 110 of the fiber block 11, the inner portion 116 is mirror-polished.

On the other hand, in the end face 110 of the fiber block 11 (the end faces of the V-groove substrate 112 and the pressing lid 113), the outer portion 117 is a rough surface and has unevenness.

In the optical module 10, an adhesive (for example, an ultraviolet-curable adhesive) having an adhesive strength is filled (attached) between the outer portion 117 of the end face of the fiber block 11 and the end face of the optical waveguide element chip 12 facing the outer portion 117, and the fiber block 11 and the optical waveguide element chip 12 are fixed.

In addition, in consideration of propagation of high-output (for example, about 1 W) light, a resin having light resistance is filled between the inner portion 316 of the end face of the fiber block 11 and the end face of the optical waveguide element chip 12 facing the inner portion 316. Here, the gap between the end faces of the inner portion 316 may be configured to be air, or the fiber block 11 and the optical waveguide element chip 12 may be configured to be in physical contact with each other without being filled with a resin having light resistance.

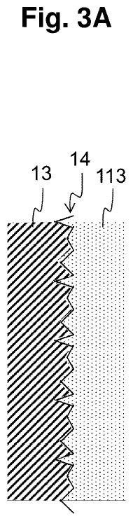

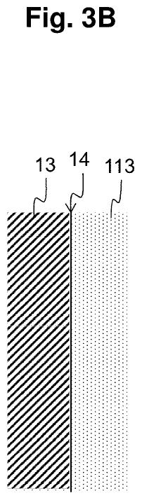

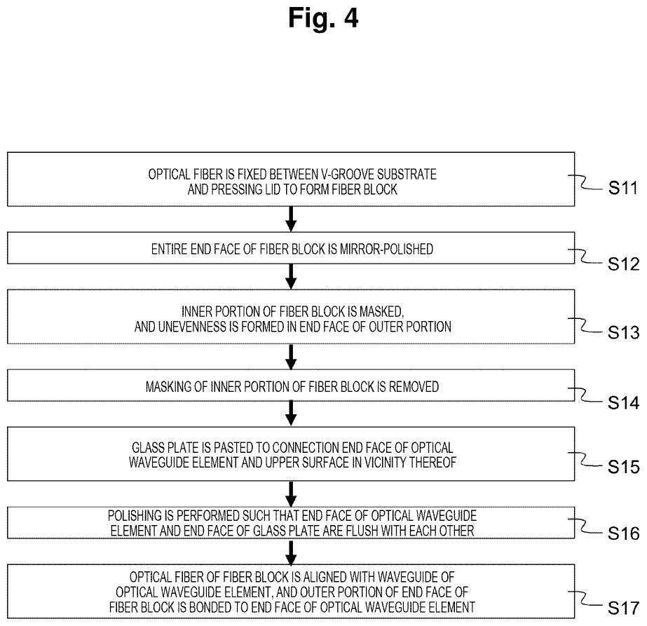

FIG. 3A illustrates, as an example, a cross-sectional view of an end face of the outer portion 117 of the pressing lid 113 to which an adhesive 13 is attached in the fiber block 11 according to the present embodiment. For comparison, FIG. 4B illustrates a cross-sectional view of the end face of the outer portion 117 of the pressing lid 113 to which the adhesive is attached in the fiber block 11 in the related art.

In the fiber block 11 in the related art, as illustrated in FIG. 4B, the end face of the outer portion 117 is mirror-polished and flat.

On the other hand, in the fiber block 11 according to the present embodiment, as illustrated in FIG. 4A, the end face of the outer portion 117 has unevenness and is a rough surface. As a result, the bonding area can be increased, and the bonding strength can be increased.

The arithmetic average roughness Ra of the unevenness on the end face of the outer portion 117 of the fiber block 11 will be described. The arithmetic average roughness Ra is obtained by integrating an absolute value of a deviation from an average value of the unevenness in a reference length and dividing an integrated value by the reference length, and corresponds to an average of heights of the unevenness. Here, an interval between the unevenness is in the same order as the order of the heights of the unevenness.

First, the interval between the end face of the optical fiber 111 in the fiber block 11 and the end face of the optical waveguide in the optical waveguide element chip 12 is equal to or longer than 1 μm and equal to or shorter than 10 μm, and is appropriately determined by characteristics of the adhesive to be filled between the end faces. For example, the interval between the end faces is determined to be 1 to 10 times the wavelength of the guided light. In a case where it is assumed that the wavelength of the guided light is approximately 1 μm, the interval between the end faces is 1 μm to 10 μm.

In a case where the Ra of the unevenness is set to be smaller than 1/10 of the wavelength of the guided light, smoothness of the end face is equivalent to smoothness of the end face in a case where mirror-polishing is performed. Therefore, since the unevenness is reduced, the effect of increasing the bonding area is reduced.

On the other hand, in a case where the Ra of the unevenness is set to be larger than 10 times the wavelength of the guided light, the interval between the end faces becomes longer. As a result, the adhesive to be filled may be insufficient. In addition, stress may occur in the connection portion due to curing shrinkage of the adhesive. As a result, long-term reliability may be lowered.

Therefore, it is desirable that the Ra of the unevenness is equal to or larger than 1/10 of the wavelength of the guided light and equal to or smaller than 10 times the wavelength of the guided light. In addition, in a case where the wavelength of the guided light is approximately 1 μm, it is desirable that the Ra of the unevenness is equal to or larger than 0.1 μm and equal to or smaller than 10 μm. Here, the heights of the unevenness do not need to be uniform, and may be non-uniform.

### Method for Manufacturing Optical Module

An example of a method for manufacturing optical module 10 according to the present exemplary embodiment will be described. Here, connection between the fiber block 11 and the optical waveguide element chip 12 in the optical module 10 will be mainly described. FIG. 4 is a flowchart illustrating an example of a method for manufacturing the optical module 10.

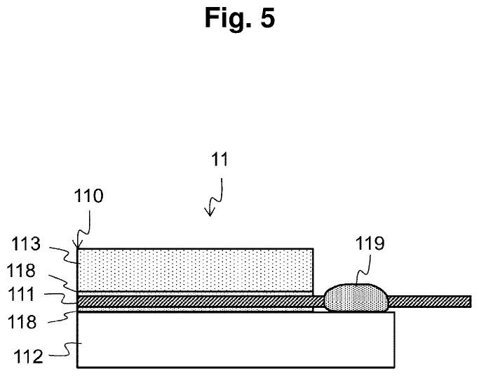

First, as illustrated in FIG. 5, the optical fiber 111 is fixed between the V-groove substrate 112 and the pressing lid 113 with an adhesive 118 to form a fiber block 11 (step S11). Here, a jacket portion (a polymer portion protecting the glass portion) of the optical fiber 111 is disposed in an exposed portion (a portion not sandwiched by the pressing lid 113) of the optical fiber 111 (not illustrated). In addition, the optical fiber 111 is fixed to the V-groove substrate 112 by an elastic adhesive 119.

Here, the separation groove 114 is formed in each of the V-groove substrate 112 and the pressing lid 113 before the fiber block 11 is formed.

Next, the entire end face 110 of the fiber block 11 is polished (step S12). Here, the end face 110 of the fiber block 11 supported by a jig is pressed against the surface of the polishing table into which the polishing liquid is poured, and the polishing is performed. As the polishing liquid, a liquid mixed with polishing abrasive grains is used.

In the polishing, first, rough polishing is performed, and the end face 110 of the fiber block 11, that is, the end faces of the pressing lid 113, the optical fiber 111, and the V-groove substrate 112 are polished so as to be flush with each other.

As the end face 110 becomes smooth, the polishing liquid is replaced, the grain size of the polishing abrasive grains is reduced, and polishing is performed until the end face 110 becomes a mirror surface, that is, until Ra becomes about 1/100 of the wavelength or Ra becomes about 0.01 μm.

Next, in the fiber block 11, the inner portion 116 is masked, and the end face of the outer portion 117 is formed into a rough surface (surface having unevenness) using a sandblasting method (step S13). The sandblasting method is a method of processing a rough surface by mixing and spraying an abrasive in compressed air. The masked portion is maintained in a mirrored state as the abrasive is not sprayed onto the masked inner portion 116.

Here, since the end face of the outer portion 117 is roughly processed after the entire surface is mirror-polished, the end face is recessed from the end face of the inner portion 116 in the mirror surface state.

In addition, in the end face 110, since the inner portion 116 in the mirror surface state and the outer portion 117 of the rough surface are separated by the separation groove 114, the boundary between them is clear. As a result, since the region to be masked becomes clear, masking can be easily performed. For example, masking can be performed by attaching a masking tape while observing with a microscope.

Next, in the fiber block 11, the masking of the inner portion 116 is removed (step S14).

On the other hand, in the optical waveguide element chip 12, the glass plate 123 is pasted to the connection end face of the optical waveguide element chip 12 and the upper surface in the vicinity thereof (step S15).

Next, as described above, polishing is performed such that the end face of the optical waveguide element chip 12 and the end face of the glass plate 123 are flush with each other, and polishing is stopped when Ra of the end face becomes about the wavelength of the guided light (about 1 μm) (step S16).

Finally, the optical fiber 111 of the fiber block 11 is aligned with the waveguide of the optical waveguide element chip 12, and the outer portion 117 of the end face of the fiber block 11 and the end face of the optical waveguide element chip 12 (including the glass plate 123) facing the outer portion 117 are bonded by an ultraviolet-curable adhesive 13 (step S17).

In this manner, the optical module 10 is manufactured by connecting the fiber block 11 and the optical waveguide element chip 12.

According to the optical component and the optical module according to the present embodiment, the fiber block 11 and the optical waveguide element chip 12 can be firmly fixed (bonded). In addition, the optical module can be downsized without reducing the bonding strength between the fiber block 11 and the optical waveguide element chip 12.

In the present embodiment, an example in which the entire surface of the outer portion 117 of the fiber block 11 has unevenness has been described, but the present invention is not limited thereto. If at least a part of the outer portion 117 of the fiber block 11 has unevenness, the bonding strength can be improved as compared with the case where the entire outer portion 117 is in the mirror-polished state. Here, it is desirable that an area of the portion having unevenness is equal to or larger than ¼ of the total area of the outer portion 117.

### Second Embodiment

An optical module according to a second embodiment of the present invention will be described. The configuration of the optical module according to the present embodiment is the same as that of the first embodiment.

### Method for Manufacturing Optical Module

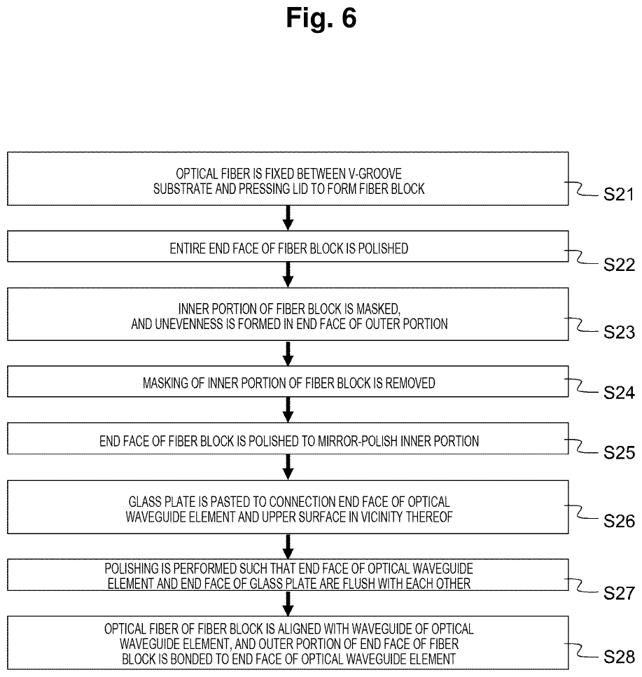

An example of a method for manufacturing an optical module according to the present embodiment will be described. In the method for manufacturing an optical module according to the first embodiment, an example has been described in which the inner portion 116 of the end face 110 of the fiber block 11 is mirror-polished, and then a rough surface is formed on the outer portion 117 of the separation groove 114. In the method for manufacturing an optical module according to the present embodiment, a rough surface is formed on the outer portion 117 of the end face 110 of the fiber block 11, and then mirror-polishing is performed on the inner portion 116. FIG. 6 is a flowchart illustrating an example of the method for manufacturing the optical module according to the present exemplary embodiment.

First, as described in the first embodiment, the optical fiber 111 is fixed between the V-groove substrate 112 and the pressing lid 113 with the adhesive 118 to form the fiber block 11 (step S21).

Next, when the end face of the fiber block 11 is polished, polishing is stopped at a stage before the end face 110 becomes a mirror surface state after the end face 110 becomes substantially flush (step S22).

Next, in the end face 110, the inner portion 116 is masked, and the outer portion 117 is processed by a sandblasting method or the like to form a rough surface (step S23). As a result, since the outer portion 117 is processed, the outer portion 117 is recessed from the end face 110 as compared with the inner portion 116.

Next, in the fiber block 11, the masking of the inner portion 116 is removed (step S24).

Next, the end face 110 of the fiber block 11 is polished to mirror-polish the inner portion 116 (step S25). Here, since the outer portion 117 is recessed from the end face 110, the outer portion 117 is not polished.

Thereafter, an optical module is manufactured in steps similar to those in the first embodiment (steps S26 to S28).

In the method for manufacturing the optical module according to the first embodiment, after the entire end face 110 is mirror-polished, the inner portion 116 is masked to process the outer portion 117, and the masking of the inner portion 116 is finally removed. In this case, a part of the masking material may remain in the inner portion 116. As a result, the characteristics of the optical module are deteriorated, such as the quality of the end face of the inner portion 116, that is, a region through which light propagates, deteriorates and the optical loss at the connection portion between the fiber block 11 and the optical waveguide element chip 12 increases.

According to the method for manufacturing an optical module according to the present embodiment, since mirror-polishing is performed after a rough surface is formed on the end face 110, it is possible to eliminate the possibility that a part of the masking material remains in the inner portion 116, and it is possible to improve the quality of the end face of the inner portion 116, that is, the region through which light propagates. The optical loss at the connection portion between the fiber block 11 and the optical waveguide element chip 12 can be reduced, and the characteristics of the optical module can be improved.

In the embodiments of the present invention, an example in which the PLC chip is connected to the fiber block has been described, but the present invention is not limited thereto. In addition to the PLC chip, for example, a silicon photonics (SiPh) chip may be used, and an optical component having an optical waveguide may be used. For example, the silicon photonics is configured using Si for a waveguide core, quartz glass (SiO₂) for a waveguide cladding, and the like. A waveguide mode of the guided light is expanded by a tapered Si waveguide (spot size converter, SSC), and the guided light is finally output at an input/output end which is made of SiO₂ (without the Si waveguide). As described above, in the optical component connected to the fiber block, the input/output end is desirably made of SiO₂.

In the embodiment of the present invention, in the connection between the fiber block and the optical waveguide element, an example in which the separation groove is provided on the end face of the fiber block and the end face of the outer portion is formed as a rough (uneven) surface has been described, but the present invention is not limited thereto. A separation groove may be provided on the end face of the optical waveguide element, and the outer end face of the separation groove may be formed as a rough (uneven) surface. In addition, a separation groove may be provided on both end faces of the fiber block and the optical waveguide element, and an outer end face of the separation groove may be formed as a rough (uneven) surface. The adhesive may be attached to at least one end face of the fiber block and the optical waveguide element.

As described above, in the embodiment of the present invention, the separation grooves are disposed on both sides of the optical waveguide on the end face of the optical component having the optical waveguide such as the fiber block or the optical waveguide element, the inner end face of the separation groove is in the mirror surface state, and at least a part of the outer end face of the separation groove has unevenness.

In the embodiment of the present invention, an example in which two separation grooves are provided on the end face of the optical component has been described, but the present invention is not limited thereto, and three or more separation grooves may be provided. At least one pair of separation grooves may be provided on an end face of the optical component, an inner end face of the separation groove may be in a mirror surface state including a region through which light propagates, and an outer end face of the separation groove may be a rough (uneven) surface.

In the embodiment of the present invention, examples of the structure, dimensions, materials, and the like of each component have been described in the configuration and manufacturing method of the optical component and the optical module, but the present invention is not limited thereto. Any optical module may be used as long as the optical module exhibits a function and an effect.

### INDUSTRIAL APPLICABILITY

The embodiments of present invention relates to an optical module to which an optical component is connected, and can be applied to an optical communication field and a sensing field.

### REFERENCE SIGNS LIST

11 Fiber block (optical component)
110 End face of fiber block (optical component)
111 Optical fiber (optical waveguide)
114 Separation groove
116 Inner end face of separation groove
117 Outer end face of separation groove
12 Optical waveguide element (another optical component)

1-6. (canceled)

7. An optical component, comprising:
an optical waveguide; and
a separation groove disposed on both sides of the optical waveguide in an end face of the optical component connected to face an end face of another optical component, wherein:
the end face inside the separation groove is in a mirror surface state,
at least a part of the end face outside the separation groove has unevenness, and
an arithmetic average roughness of the unevenness is equal to or larger than 1/10 of a wavelength of light propagating through the optical waveguide and equal to or smaller than 10 times the wavelength of the light.

8. The optical component according to claim 7, wherein an arithmetic average roughness of the unevenness is equal to or larger than 1/10 of a wavelength of light propagating through the optical waveguide and equal to or smaller than 10 times the wavelength of the light.

9. The optical component according to claim 7, further comprising:
an optical fiber having the optical waveguide;
a V-groove substrate having a V-shaped groove in which the optical fiber is disposed; and
a pressing lid that fixes the optical fiber by sandwiching the optical fiber with the V-groove substrate.

10. The optical component according to claim 7, wherein the end face outside the separation groove is recessed from the end face inside the separation groove.

11. The optical component according to claim 7, wherein the arithmetic average roughness of the unevenness is between 0.1 μm and 10 μm.

12. The optical component according to claim 7, further comprising at least three separation grooves on the end face.

13. The optical component according to claim 7, wherein the optical waveguide is configured to propagate high-output light of 1 W.

14. The optical component according to claim 9, wherein the optical fiber is fixed to the V-groove substrate by an elastic adhesive.

15. The optical component according to claim 7, wherein the optical component is connected to another optical component at respective end faces, and at least a portion of the end face having the unevenness is bonded to the other optical component by an adhesive.

16. The optical component according to claim 15, wherein the adhesive has a refractive index equivalent to that of glass with respect to light in a communication region of near-infrared light from a wavelength of 1.3 μm to a wavelength of 1.6 μm.

17. A method for manufacturing an optical module, the method comprising:
mirror-polishing an entire surface of an end face of a first optical component, wherein the first optical component includes an optical waveguide and separation grooves on both sides of the optical waveguide at the end face;
forming a masking inside the separation grooves on the end face of the first optical component, and forming unevenness outside the separation grooves;
removing the masking; and
aligning the optical waveguide of the first optical component with an optical waveguide of a second optical component, and bonding an outer side of the end face of the first optical component to an end face of the second optical component.

18. The method according to claim 17, wherein forming the unevenness comprises using a sandblasting method.

19. The method according to claim 17, wherein bonding comprises using an ultraviolet-curable adhesive.

20. The method according to claim 17, further comprising filling a light-resistant resin between the end faces of the first and second optical components in a region inside the separation grooves.

21. The method according to claim 17, wherein the first and second optical components are connected at their respective end faces.

22. A method for manufacturing an optical module, the method comprising:
polishing an entire end face of a first optical component, wherein the first optical component includes an optical waveguide and separation grooves on both sides of the optical waveguide at the end face;
forming a masking inside the separation grooves on the end face of the first optical component, and forming unevenness outside the separation grooves;
removing the masking;
mirror-polishing an inner side of the end face of the first optical component; and
aligning the optical waveguide of the first optical component with an optical waveguide of a second optical component, and bonding an outer side of the end face of the first optical component to an end face of the second optical component.

23. The method according to claim 22, wherein forming the unevenness comprises using a sandblasting method.

24. The method according to claim 22, wherein bonding comprises using an ultraviolet-curable adhesive.

25. The method according to claim 22, further comprising filling a light-resistant resin between the end faces of the first and second optical components in a region inside the separation grooves.
